(19) United States
(12) Patent Application Publication
(10) Pub. No.: US 2006/0161950 A1
(43) Pub. Date: Jul. 20, 2006

(54) Program recommending apparatus, program recommended apparatus, and program recommending system

(75) Inventors: Shigeru Imai, Tokyo (JP); Masami Matsubara, Tokyo (JP); Shinji Akatsu, Tokyo (JP); Shin Miura, Tokyo (JP)

Correspondence Address: BIRCH STEWART KOLASCH & BIRCH, PO BOX 747, FALLS CHURCH, VA, 22040-0747, US

(73) Assignee: MITSUBISHI KABUSHIKI KAISHA, Tokyo (JP)

(21) Appl. No.: 10/548,884

(22) PCT Filed: Jan. 27, 2004
(86) PCT No.: PCT/JP04/00717

§ 371 Date: Sep. 14, 2005

(51) Int. Cl. H04N 5/445; H04N 7/10; G06F 13/00; H04N 7/025; G06F 3/00

(52) U.S. Cl. 725/46; 725/34; 725/35

(57) ABSTRACT

When carrying out program recommendation between friends and acquaintances, only information necessary for identifying a recommendation program rather than the program content itself is transmitted from a program recommending terminal to a program recommended terminal. This enables recommendation of the program without using a wide communication band. Besides, a problem of copyright involved in transmitting the program contents can be circumvented.

### TECHNICAL FIELD

The present invention relates to a program recommending apparatus, a program recommended apparatus, and a program recommending system for communicating program recommendation information between terminals via a network.

### BACKGROUND ART

The need intensifies for means for selecting, according to reliable information, a good program from large amounts of program contents fed via broadcast waves or the Internet. Conventionally, the recommendation/introduction of TV programs and the like are exchanged by word of mouth of friends or acquaintances, or via communication means such as emails, or bulletin boards or chats on the Internet.

For example, in a conventional program introducing system disclosed in Japanese patent application laid-open No. 2002-218428, a program introducer informs an introduced terminal of a program he or she wishes to introduce using an introducer terminal. According to the input from an introducer watching the program, the introducer terminal generates introduction information including a program to be introduced and information to identify the scene, and information about a person to whom the program is to be introduced, and sends the introduction information to an introduction distribution server. The introduction distribution server retrieves an introduced video from the program contents stored in the control server according to the introduction information, and delivers the video to the introduced terminals. The introduced terminals each display the introduced video, and if a viewing request of the program body occurs, they send a program body viewing request to the introduction distribution server. The introduction distribution server retrieves the contents of the program body from the control server, and distributes the program body to the introduced terminals.

With the foregoing configuration, the conventional program introducing system has a problem of copyright because the contents of the program body are redistributed to the introduced terminals via the network. In particular, since digital copy is characterized by not being degraded, the problem is expected to become more important as the digital broadcasting comes into full swing.

In addition, another problem takes place of using large amounts of communication bands by transmitting data of the program body.

The present invention is implemented to solve the foregoing problems. Therefore it is an object of the present invention to provide a program recommending apparatus, a program recommended apparatus, and a program recommending system capable of circumventing the copyright infringement, reducing the communication data volume, and implementing efficient program introduction.

### DISCLOSURE OF THE INVENTION

According to one aspect of the present invention, there is provided a program recommending apparatus that transmits program recommendation information to a program recommended apparatus via a communication circuit, the program recommending apparatus comprising: a program information acquiring section for supplying program information about a program currently broadcast or about a program to be broadcast in the future; a program recommendation information generating section for generating, according to a program currently viewed or to a program designated from among the program information supplied from the program information acquiring section, program recommendation information that includes information for identifying the program; a recommendation destination identifying section for generating a list of a program recommended apparatus to which the program recommendation information can be transmitted; an interface for displaying the list, and for receiving an input for designating a program recommended apparatus; and a communication section for transmitting the program recommendation information to the program recommended apparatus designated.

Thus, it notifies the program recommended apparatus of only the information for identifying the program recommended by a program recommender rather than the program itself. As a result, it makes it possible to circumvent the copyright infringement of the program contents, and to make effective use of the communication band.

According to another aspect of the present invention, there is provided a program recommended apparatus that receives program recommendation information transmitted from a program recommending apparatus via a communication circuit, the program recommended apparatus comprising: a program information acquiring section for supplying program information about a program currently broadcast or about a program to be broadcast in the future; a communication section for receiving the program recommendation information transmitted from the program recommending apparatus; a program recommending source management table for storing authorization information for making a decision as to whether to authorize a program recommendation from the program recommending apparatus; a program recommending source authentication section for supplying, referring to the program recommending source management table, authorization information given to the program recommending apparatus; a program recommending section, referring to the authorization information supplied from the program recommending source authentication section, for identifying, when the program recommending apparatus is provided with authorization of recommendation authorized, a program included in the program recommendation information from among the program information supplied from the program information acquiring section; and a display section for displaying recommendation information based on the program recommendation information about the program identified by the program recommending section.

Thus, the user of the program recommended apparatus can view the program only in accordance with the program recommendation information from a reliable recommender.

According to still another aspect of the present invention, there is provided a program recommending system that transmits program recommendation information from a program recommending apparatus to a program recommended apparatus via a communication circuit, wherein the program recommending apparatus: generates, according to a program designated from a program currently viewed or to a program designated from among program information about a program currently broadcast and about a program to be broadcast in the future, the program recommendation information including information for identifying the program; and transmits the program recommendation information to a program recommended apparatus designated from a list of program recommended apparatuses to which the program recommendation information can be transmitted, and wherein the program recommended apparatus that receives the program recommendation information: referring to a program recommending source management table that stores authorization information for making a decision as to whether to authorize program recommendation from the program recommending apparatus, displays, when the program recommending apparatus is provided with authorization of recommendation authorized, the recommendation information based on the program recommendation information.

This makes it possible to circumvent the copyright infringement of the program contents, and to make effective use of the communication band. In addition, the user of the program recommended apparatus can view the program only in accordance with the program recommendation information from a reliable recommender.

### BRIEF DESCRIPTION OF THE DRAWINGS

FIG. 1 is a diagram showing a configuration of a program recommending system of an embodiment 1 in accordance with the present invention;

FIG. 2 is a block diagram showing a configuration of a program recommending terminal of the embodiment 1;

FIG. 3 is a block diagram showing a configuration of a program recommended terminal of the embodiment 1;

FIG. 4 is a diagram illustrating the operation of the program recommending terminal of the embodiment 1;

FIG. 5 is a view showing a screen display for checking program recommendation information at the program recommending terminal of the embodiment 1;

FIG. 6 is a view showing a screen display for inputting a program recommendation message at the program recommending terminal of the embodiment 1;

FIG. 7 is a diagram illustrating the operation of the program recommended terminal of the embodiment 1;

FIG. 8 is a diagram showing the content of a program recommending source management table of the embodiment 1;

FIG. 9 is a view showing a screen display for displaying the program recommendation information at the program recommended terminal of the embodiment 1;

FIG. 10 is a block diagram showing a configuration of a program recommending terminal of an embodiment 2;

FIG. 11 is a block diagram showing a configuration of a program recommended terminal of the embodiment 2;

FIG. 12 is a diagram showing the content of the program recommending source management table of the embodiment 2; and

FIG. 13 is a view showing a screen display for designating a recommendable scene at the program recommending terminal of an embodiment 3.

### BEST MODE FOR CARRYING OUT THE INVENTION

The best mode for carrying out the invention will now be described with reference to the accompanying drawings to explain the present invention in more detail.

### Embodiment 1

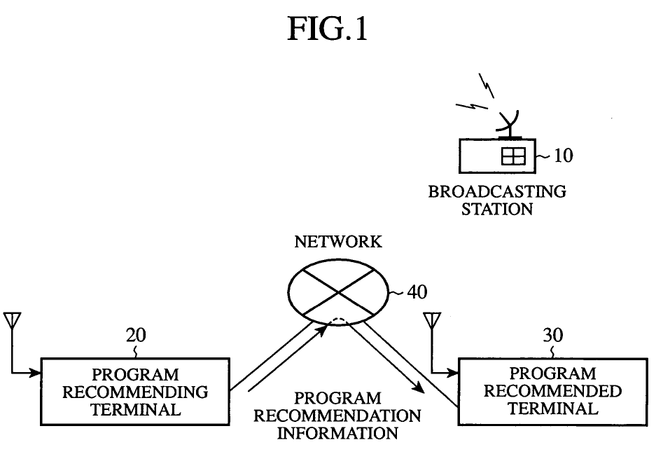

FIG. 1 is a diagram showing a configuration of a program recommending system of an embodiment 1 in accordance with the present invention. As shown in FIG. 1, the program recommending system includes a broadcasting station 10, a program recommending terminal 20, a program recommended terminal 30, and a network 40.

The program recommending terminal 20 and the program recommended terminal 30 are connected via the network 40.

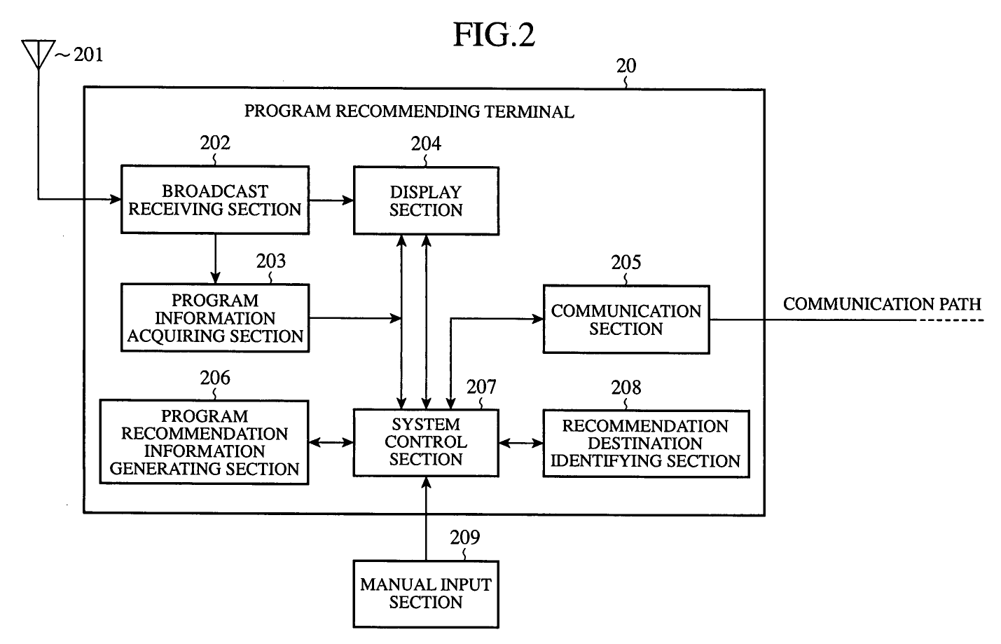

FIG. 2 is a block diagram showing a configuration of the program recommending terminal 20 of the embodiment 1. As shown in FIG. 2, the program recommending terminal 20 includes an antenna 201, a broadcast receiving section 202, a program information acquiring section 203, a display section (interface) 204, a communication section 205, a program recommendation information generating section 206, a system control section 207, a recommendation destination identifying section 208, and a manual input section (interface) 209.

The broadcast receiving section 202, program information acquiring section 203, communication section 205, program recommendation information generating section 206, system control section 207, and recommendation destination identifying section 208 constitute a processor of the program recommending terminal 20 and a redivided according to the modules of the software for controlling the operation of the processor.

The antenna 201 receives a broadcast wave from the broadcasting station 10. The contents of the signal received via the antenna 201 include not only the program contents themselves, but also the program information about programs to be broadcast. The program information includes information such as a program ID for identifying the program, a program title, the channel, broadcast time, genre and keywords of each program.

The display section 204 is a device such as a display, and the manual input section 209 is an input device for a user to make manual input to the program recommending terminal 20.

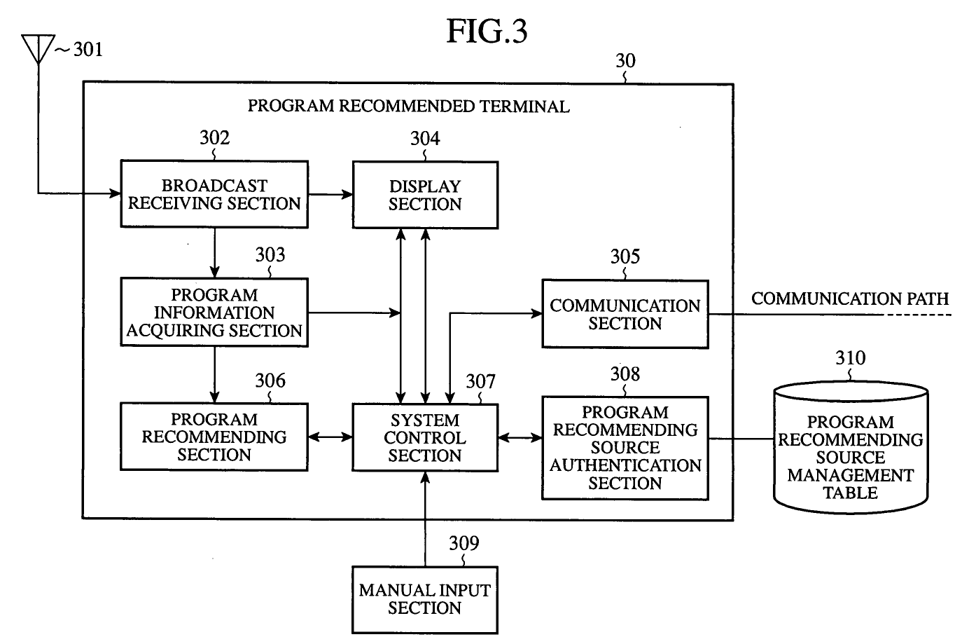

FIG. 3 is a block diagram showing a configuration of the program recommended terminal 30 of the embodiment 1. As shown in FIG. 3, the program recommended terminal 30 includes an antenna 301, a broadcast receiving section 302, a program information acquiring section 303, a display section 304, a communication section 305, a program recommending section 306, a system control section 307, a program recommending source authentication section 308, a manual input section 309, and a program recommending source management information storing section 310.

The broadcast receiving section 302, program information acquiring section 303, communication section 305, program recommending section 306, system control section 307, and program recommending source authentication section 308 constitute the processor of the program recommended terminal 30, and are divided according to the modules of the software for controlling the operation of the processor.

The antenna 301 receives a broadcast wave from the broadcasting station 10. The contents of the signal received via the antenna 301 include not only the program contents themselves, but also the program information about programs to be broadcast. The program information includes information such as a program ID for identifying the program, a program title, the channel, broadcast time, genre and keywords of each program.

The display section 304 is a device such as a display, and the manual input section 309 is an input device for a user to make manual input to the program recommended terminal 30.

The program recommending source management information storing section 310 is an internal memory unit of the program recommended terminal 30, or an external memory unit connected via a communication circuit. The program recommending source management information storing section 310 stores a program recommending source management table.

Next, the operation will be described.

First, the program recommending processing by the program recommending terminal 20 will be described.

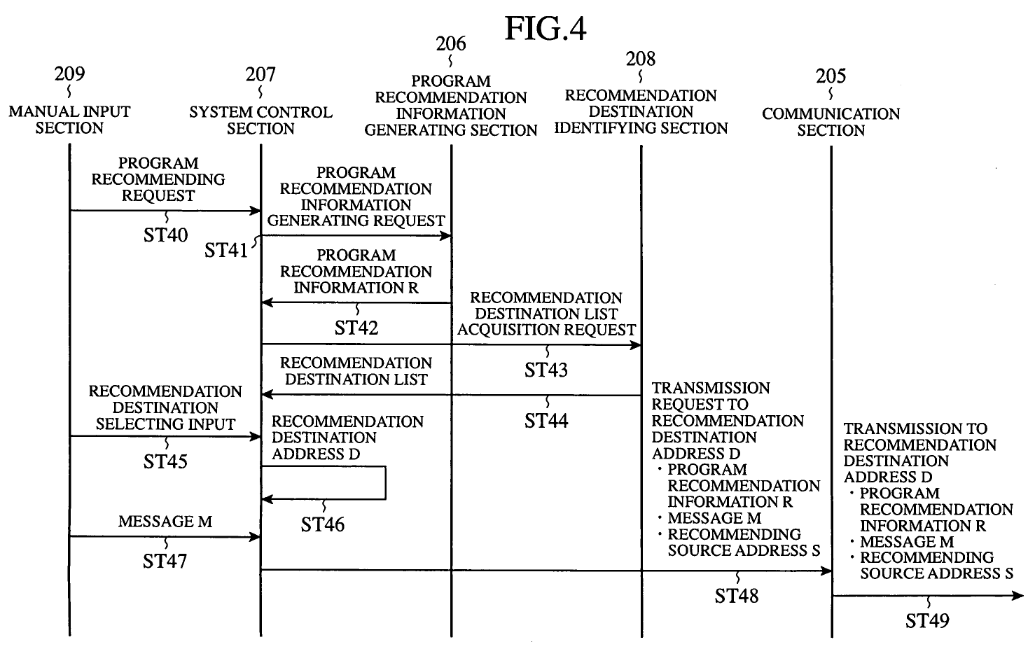

FIG. 4 is a diagram illustrating the operation of the program recommending terminal 20. First, the user designates a recommendable program via the manual input section 209, and a designated program recommending request is fed to the system control section 207 (step ST40).

When the user nominates the recommendable program using the manual input section 209, the user can first nominate the program he or she is viewing. Alternatively, the user can have the display section 204 display on the screen the information about a program currently broadcast or to be broadcast in the future, which is obtained by the program information acquiring section 203 via the broadcast receiving section 202, and select a program therefrom.

Next, receiving the program recommending request from the manual input section 209, the system control section 207 supplies the program recommendation information generating section 206 with a program recommendation information generating request (step ST41). The program recommendation information generating request includes the program information on the program the user selects.

According to the program information received, the program recommendation information generating section 206 generates program recommendation information R, and supplies it to the system control section 207 (step ST42).

The program recommendation information R generated by the program recommendation information generating section 206 can include the program IDs of the individual programs in the program information supplied. In this case, the program recommended terminal 30 can identify the recommendable programs using the program IDs when it receives the program recommendation information from the program recommending terminal 20.

Instead of the program IDs, the program recommendation information R can use a combination of a plurality of items of information such as the genre, keyword, channel, and broadcast time period of the programs recommended by the user. In this case, the program recommended terminal 30 can identify a plurality of programs that meet these conditions as the recommendable programs.

Alternatively, when it is detected that the user watches the same program for more than a predetermined time period by observing the program viewing time period of the user, the program ID of the program can be automatically inserted into the program recommendation information R.

The program recommendation information R can also be generated by presuming the genre, keyword, channel, broadcast hour and the like of the program the user likes according to the program viewing tendency of the user.

Alternatively, according to the designated program information, the program recommendation information generating section 206 may generate all or part of the software module corresponding to the functions of the program recommending section 306 of the program recommended terminal 30 which will be described later, and employ the generated one as the program recommendation information R.

Acquiring the program recommendation information R from the program recommendation information generating section 206, the system control section 207 supplies the recommendation destination identifying section 208 with a recommendation destination list acquisition request (step ST43).

The recommendation destination identifying section 208 supplies a preregistered recommendation destination list to the system control section 207 (step ST44). The recommendation destination list brings the name of the user possessing the program recommended terminal 30 into correspondence with the address information for identifying the program recommended terminal 30 on the network. Although the form of the address information depends on the communication path, it is an IP address for an IP network, and a telephone number for a telephone network.

Having acquired the recommendation destination list, the system control section 207 instructs the display section 204 to display a program recommendation information confirmation dialogue 51 as shown in FIG. 5 on the screen. As shown in FIG. 5, the program recommendation information confirmation dialogue 51 includes a program title designating region 52, a program recommendation destination designating region 53, a recommendation confirmation button 54, and a recommendation cancellation button 55.

In the program title designating region 52, the title of the recommendable program designated at step ST40 is displayed. The program recommendation destination designating region 53, which is an interface capable of displaying a plurality of choices such as a list box, displays user names contained in the recommendation destination list the system control section 207 acquires from the recommendation destination identifying section 208.

When the program recommendation information confirmation dialogue 51 is displayed, the user operates the manual input section 209 to select the user name to whom the program is to be recommended from the program recommendation destination designating region 53. Then, confirming the recommendable program in the program title designating region 52, the user selects the recommendation confirmation button 54. Once the recommendation confirmation button 54 is selected via the manual input section 209, the recommendation destination selecting input is supplied to the system control section 207 (step ST45).

In contrast, to cancel the recommendation of the program, the user selects the recommendation cancellation button 55 in the program recommendation information confirmation dialogue 51. Thus, the program recommending processing is halted.

Receiving the recommendation destination selecting input at step ST45, the system control section 207 acquires from the recommendation destination list acquired at step ST44 the network address D of the program recommended terminal 30 corresponding to the user name of the received recommendation destination (step ST46).

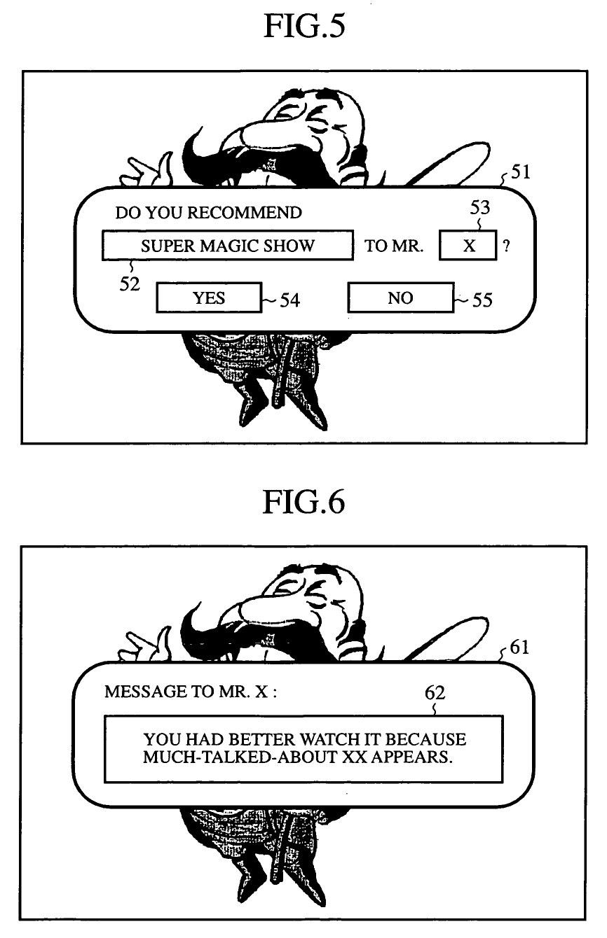

Acquiring the network address D of the recommendation destination, the system control section 207 instructs the display section 204 to display a program recommendation message input dialogue 61 as shown in FIG. 6 on the screen. As shown in FIG. 6, the program recommendation message input dialogue 61 includes a message input region 62.

When the program recommendation message input dialogue 61 is displayed, the user operates the manual input section 209 to input into the message input region 62 a message to a recommended person. The input message information M is supplied to the system control section 207 (step ST47).

Then the system control section 207 supplies the communication section 205 with a program recommendation information transmission request to the program recommended terminal 30 specified by the network address D (step ST48).

The program recommendation information transmission request includes the program recommendation information R, message information M, and recommending source address S which is the network address of the program recommending terminal 20.

Receiving the program recommendation information transmission request, the communication section 205 transmits these items of information to the network address D of the program recommended terminal 30, the recommendation destination, via the network 40 (step ST49).

Thus, the transmission processing of the program recommendation information by the program recommending terminal 20 has been completed.

Next, the operation will be described of the program recommended terminal 30 that receives the program recommendation information from the program recommending terminal 20.

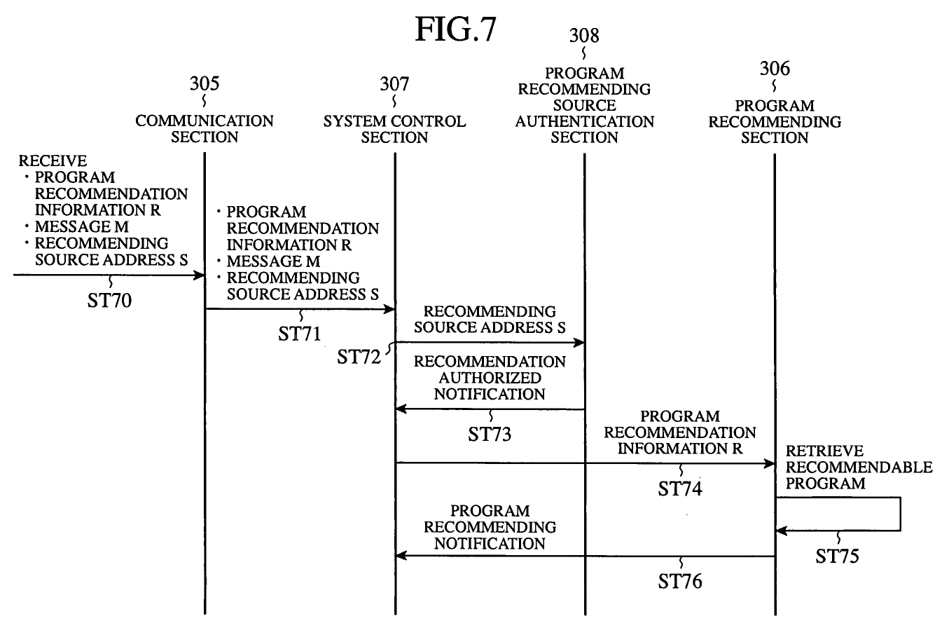

FIG. 7 is a diagram illustrating the operation of the program recommended terminal 30.

The communication section 305 receives the program recommendation information R, message information M, and recommending source address S transmitted from the program recommending terminal 20 via the network 40 (step ST70).

The communication section 305 supplies the received data to the system control section 307 (step ST71).

The system control section 307 supplies the program recommending source authentication section 308 with the received recommending source address S (step ST72).

The program recommending source authentication section 308, referring to the program recommending source management table stored in the program recommending source management information storing section 310, checks the authorization of the program recommending terminal 20 specified by the recommending source address S supplied.

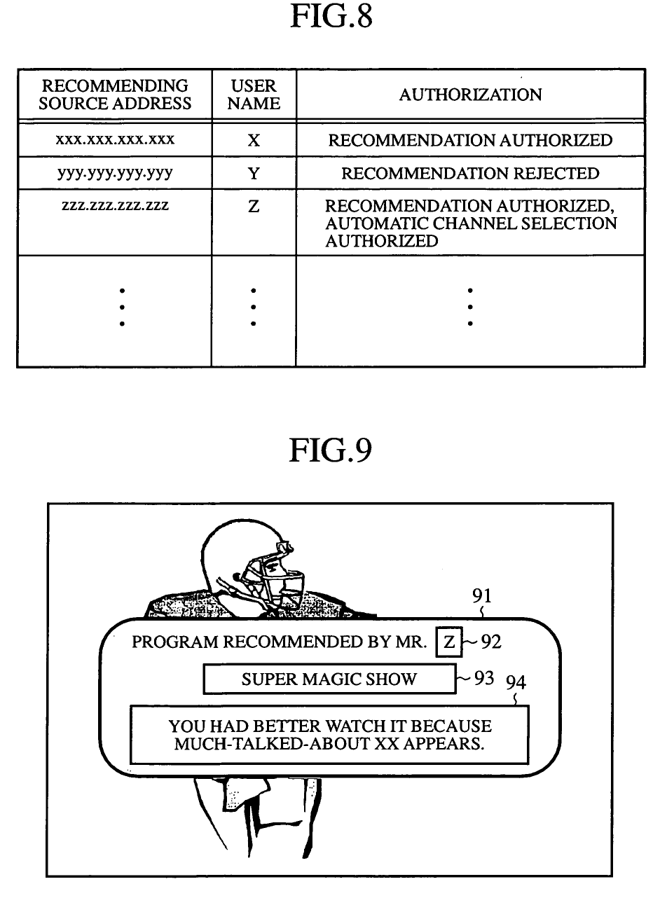

FIG. 8 is a diagram showing the contents of the program recommending source management table. As shown in FIG. 8, the program recommending source management table stores the recommending source address, which indicates the network address of the recommending source which is the program recommending terminal 20, the user name of the owner of the program recommending terminal 20, and the content of the authorization given to the program recommending terminal 20, and these items are associated with each other.

The program recommending source authentication section 308 supplies the system control section 307 with the authorization given to the program recommending terminal 20 specified by the transmission source address S. For example, if the authorization is a “recommendation authorized”, the program recommending source authentication section 308 supplies the system control section 307 with the recommendation authorized notification and the user name of the owner of the program recommending terminal 20 (step ST73). If no recommending source address that matches the transmission source address S is registered in the program recommending source management table, the program recommending source authentication section 308 can supply the system control section 307 with one of the “recommendation authorized” and “recommendation rejected” as a default notification. Such a configuration is also possible that enables the user to set one of the “recommendation authorized” and “recommendation rejected” as the default notification.

Receiving the recommendation authorized notification from the program recommending source authentication section 308, the system control section 307 supplies the program recommending section 306 with the program recommendation information R acquired at step ST71 (step ST74).

According to the program recommendation information R supplied, the program recommending section 306 retrieves the recommendable program (step ST75).

The program recommending section 306 retrieves the recommended program from the program information acquired via the program information acquiring section 303. As for the retrieving method, when the program recommendation information R includes the program ID, for example, the program recommending section 306 identifies the program according to the program ID. Alternatively, when the program recommendation information R includes conditions such as the broadcast time period and keyword of the program, the program recommending section 306 extracts the program that meets the conditions.

If the recommendable program retrieved is currently broadcast, the program recommending section 306 sends to the system control section 307 the program recommending notification with the program information retrieved (step ST76).

Receiving the program recommending notification, the system control section 307 instructs the display section 304 to display a program recommendation information dialogue 91 on the screen as illustrated in FIG. 9. As shown in FIG. 9, the program recommendation information dialogue 91 includes a program recommender display region 92, a program title display region 93, and a message display region 94.

The program recommender display region 92 displays the user name of the owner of the program recommending terminal 20 acquired at step ST73. The program title display region 93 displays the title of the recommended program acquired at step ST76. The message display region 94 displays the message M from the program recommender acquired at step ST71.

If the notification from the program recommending source authentication section 308, which is acquired at step ST73, includes an “automatic channel selection authorized”, the system control section 307 instructs the broadcast receiving section 302 to select the channel of the broadcasting station of the recommended program.

If the recommendable program notified at step ST74 is a program to be broadcast in the future, the program recommending section 306 temporarily stores the information about the recommendable program, and sends the program recommending notification to the system control section 307 immediately before the broadcasting start time of the program.

If the notification from the program recommending source authentication section 308, which is acquired at step ST73, is a “recommendation rejected”, the system control section 307 discards the received data at step ST71, and halts the processing.

As described above, according to the embodiment 1, when carrying out program recommendations among friends and acquaintances, only the information necessary for identifying the recommendation program rather than the program contents themselves is transmitted from the program recommending terminal to the program recommended terminal. Thus, the embodiment 1 can carry out the program recommendation without using a wide communication band. In addition, it can circumvent the problem of the copyright involved in the transmission of the program contents.

### Embodiment 2

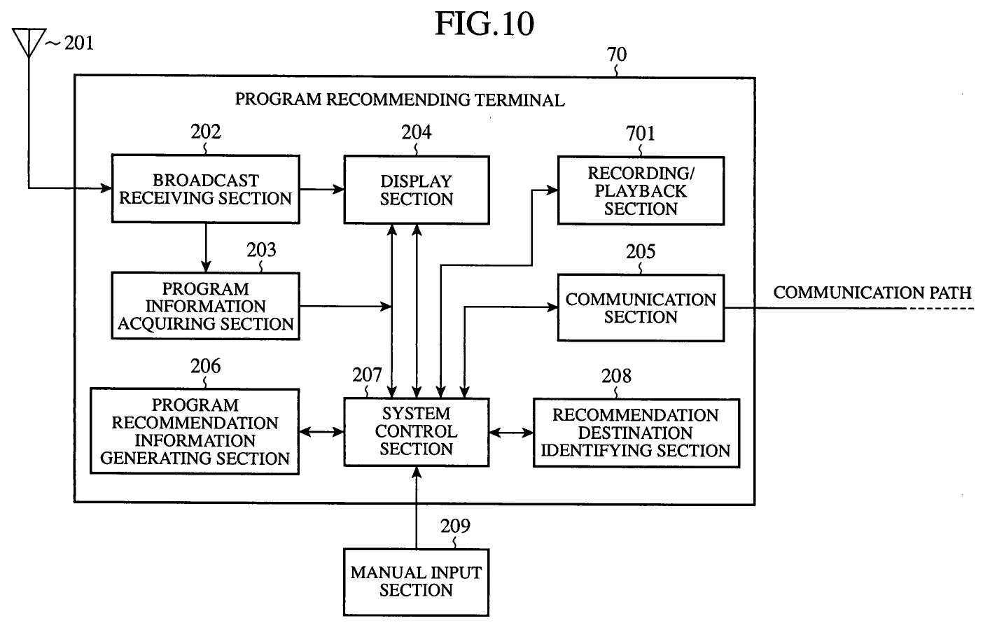

FIG. 10 is a block diagram showing a configuration of a program recommending terminal 70 of the embodiment 2 in accordance with the present invention. In FIG. 10, the same reference numerals as those of FIG. 2 designate the same components. The program recommending terminal 70 includes a record/playback section 701.

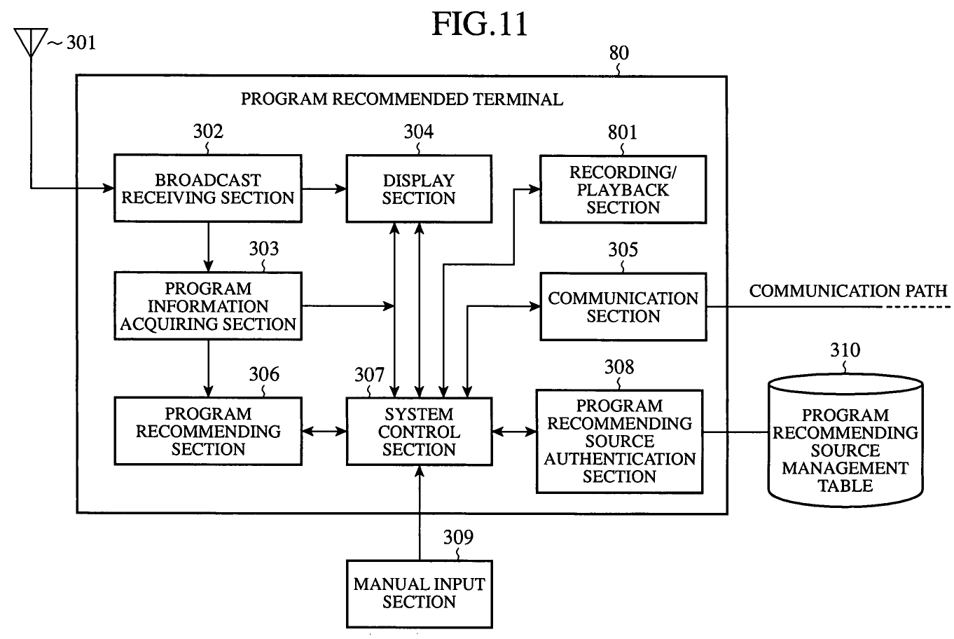

In addition, FIG. 11 is a block diagram showing a configuration of a program recommended terminal 80 of the embodiment 2. In FIG. 11, the same reference numerals as those of FIG. 3 designate the same components. The program recommended terminal 80 includes a record/playback section 801.

Next, the operation will be described.

In the embodiment 1, the user of the program recommending terminal 20 recommends only the programs currently broadcast or programs to be broadcast in the future. In the embodiment 2, the user can recommend the recorded programs managed by the record/playback section 701. In other words, the user can nominate a program recorded by the record/playback section 701 as a recommendable program via the manual input section 209.

Both the record/playback section 701 and record/playback section 801 generate, when recording the program, the program information on the recorded program, which is similar to the program information supplied by the program information acquiring section 203 and program information acquiring section 303, together with the program video, and record them.

As for a nomination method, the user can nominate the recorded program he or she is watching as in the embodiment 1, or can have the record/playback section 701 display the recorded programs it manages on the screen via the display section 204, and nominate from among them. The designated program recommending request is supplied to the system control section 207 as in the embodiment 1.

The program recommendation information generating section 206 receives the program recommendation information generating request from the system control section 207, and generates the program recommendation information R as in the embodiment 1.

In this case, such a configuration is also possible that enables the system control section 207 to instruct the program recommendation information generating section 206 to select not only the programs the user nominates as the recommendable programs, but also all the programs the user plans to record as the recommendable programs. In this case, the program recommendation information R is generated for all the reserved programs to be recorded.

The program recommending processing by the program recommending terminal 70 thereafter is the same as that of the embodiment 1 shown in FIG. 4.

Next, the operation of the program recommended terminal 80 in the embodiment 2 will be described.

As in the embodiment 1, when the communication section 305 detects the data including the program recommendation information R, message M, and recommending source address S, the received data is supplied from the communication section 305 to the system control section 307.

Subsequently, the system control section 307 supplies the program recommending source authentication section 308 with the recommending source address S received.

Referring to the program recommending source management table stored in the program recommending source management information storing section 310, the program recommending source authentication section 308 checks the authorization of the program recommending terminal 70 specified by the recommending source address S supplied.

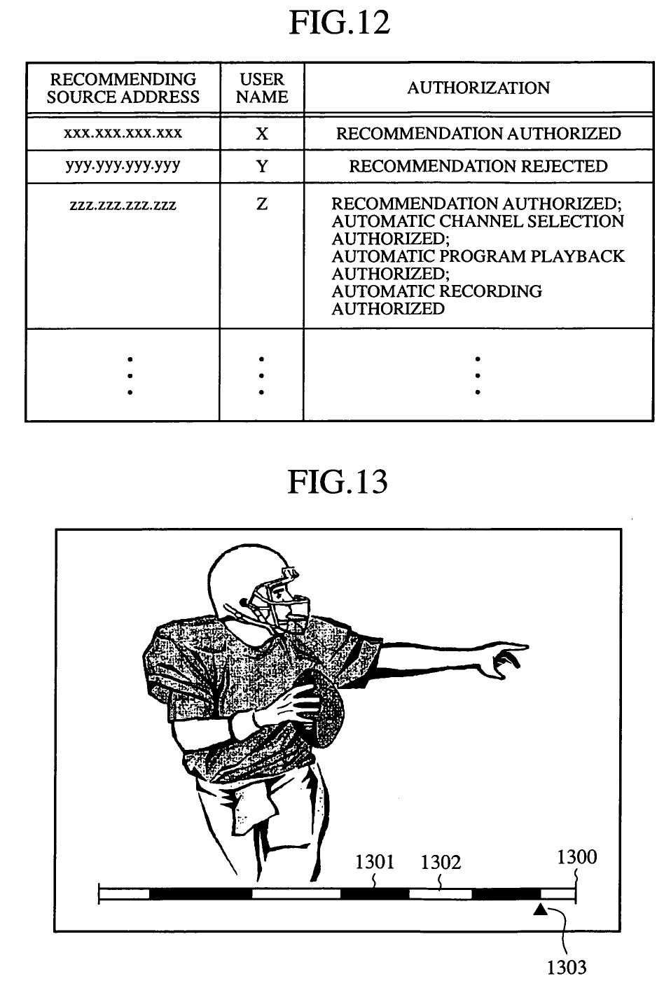

FIG. 12 is a diagram showing the contents of the program recommending source management table of the embodiment 2. As the program recommending source management table of the embodiment 1 shown in FIG. 8, the program recommending source management table stores the recommending source address, which indicates the network address of the recommending source which is the program recommending terminal 70, the user name of the owner of the program recommending terminal 70, and the content of the authorization given to the program recommending terminal 70, and these items are associated with each other. As the types of the authorization, there are “automatic program playback authorized” and “automatic recording authorized” in addition to the “recommendation authorized” and “automatic channel selection authorized”.

The program recommending source authentication section 308 supplies the system control section 307 with the authorization given to the program recommending terminal 70 specified by the transmission source address S.

Receiving the recommendation authorized notification from the program recommending source authentication section 308, the system control section 307 acquires the program information from the record/playback section 801. The system control section 307 supplies the program information and program recommendation information R to the program recommending section 306.

The program recommending section 306 searches the program information for the program recommended by the program recommendation information R, and sends, if the recommendable program is present, the program recommending notification along with the program information to the system control section 307.

Unless the recorded program information includes the recommended program, the program recommending section 306 searches the programs currently broadcast and programs to be broadcast in the future for the recommendable program as in the embodiment 1. If the recommendable program is detected, the program recommending section 306 sends to the system control section 307 the program recommending notification along with the program information.

As in the embodiment 1, the system control section 307 instructs the display section 304 to display the program recommendation information dialogue 91 as illustrated in FIG. 9 on the screen.

When the notification from the program recommending source authentication section 308 includes the “automatic program playback authorized”, the system control section 307 instructs the record/playback section 801 to play back the recommended program.

When the notification from the program recommending source authentication section 308 includes the “automatic recording authorized”, the system control section 307 instructs the record/playback section 801 to make a recording reservation of the recommendable program to be broadcast in the future, which is supplied from the program recommending section 306.

When the recording of the reserved program has been completed as described above, the record/playback section 801 sends a recording completion notification to the system control section 307. The system control section 307 instructs the display section 304 to display the program recommendation information dialogue 91 as illustrated in FIG. 9 on the screen, and notifies the user of the program recommended terminal 80 that the recommendable program has been recorded and is ready to be viewed.

As described above, according to the embodiment 2, not only the programs currently broadcast and programs to be broadcast in the future, but also the programs recorded in the past are among the recommendable objects. In this case also, since only the information necessary for identifying the recommendation program is transmitted from the program recommending terminal to the program recommended terminal, the embodiment 2 can carry out the program recommendation without using a wide communication band as in the embodiment 1. In addition, it can circumvent the problem of the copyright involved in the transmission of the program contents.

With an increase in the capacity of the storage of the recording apparatus, it is expected that large amounts of programs can be recorded from now on. In this case, the embodiment 2 can efficiently select the recommendable program from the large amounts of recorded programs.

### Embodiment 3

According to the embodiment 3, besides the functions of the embodiment 2, the program recommender can recommend the program with nominating a scene specially recommendable personally from the recorded programs.

The operation of the program recommending terminal 70 of the embodiment 3 will now be described.

When the user of the program recommending terminal 70 inputs that he or she will make the program recommendation with identifying the a program scene via the manual input section 209 during viewing a recorded program played back by the record/playback section 701, the system control section 207 instructs the display section 204 to display the screen as illustrated in FIG. 13. As illustrated in FIG. 13, a recommendable scene display bar 1300 is displayed on the screen. The recommendable scene display bar 1300 includes a recommendable scene region 1301, a non-recommendable scene region 1302, and a scene selecting slider 1303.

The user nominates a recommendable scene by moving the scene selecting slider 1303 via the manual input section 209. With the movement of the scene selecting slider 1303 to the right or left by the user, the record/playback section 701 carries out the fast forward/rewind of the program playback. The region on the recommendable scene display bar 1300 corresponding to the scene nominated by the user becomes the recommendable scene region 1301.

When the selection of the scenes has been completed, the system control section 207 supplies the selected scene information to the program recommendation information generating section 206 along with the program information on the recorded program. The program recommendation information generating section 206 generates the program recommendation information R including the program information together with the information on the selected scene supplied. The select scene is specified in terms of the playback time and the like.

The program recommending processing by the program recommending terminal 70 thereafter is the same as that of the embodiment 1 as shown in FIG. 4.

Next, the operation of the program recommended terminal 80 of the embodiment 3 will be described.

As in the embodiments 1 and 2, when the communication section 305 detects the reception of the data including the program recommendation information R, message M, and recommending source address S, the communication section 305 supplies the received data to the system control section 307.

Subsequently, the system control section 307 supplies the program recommending source authentication section 308 with the recommending source address S received.

Referring to the program recommending source management table stored in the program recommending source management information storing section 310, the program recommending source authentication section 308 notifies the system control section 307 of the authorization of the program recommending terminal 70 specified by the recommending source address S supplied.

Receiving the recommendation authorized notification from the program recommending source authentication section 308, the system control section 307 supplies the program recommending section 306 with the program information and program recommendation information R managed by the record/playback section 801.

The program recommending section 306 searches the program information for the recommendable program, and sends, if the recommendable program is present, the program recommending notification along with the program information to the system control section 307. Unless the recommended program is included in the program information, the program recommending section 306 halts the recommendation processing at that time point.

As in the embodiment 1, the system control section 307 instructs the display section 304 to display the program recommendation information dialogue 91 as illustrated in FIG. 9 on the screen.

When the notification from the program recommending source authentication section 308 includes the “automatic program playback authorized”, the system control section 307 instructs the record/playback section 801 to play back the recommended program. In this case, if the program recommendation information R includes the recommendable scene information about the recommendable program, the record/playback section 801 plays back only the recommendable scene.

Alternatively, the record/playback section 801 can play back the edition of the collection of the recommendable scenes.

Another configuration is also possible which displays the recommendable scene display bar 1300 as illustrated in FIG. 13 along with the program video to enable jumping to the recommendable scenes.

As described above, according to the embodiment 3, besides the information for identifying the programs recorded in the past, the information for identifying the scenes in the program is included in the program recommendation information. Accordingly, the user who receives the program recommendation can efficiently view only the specified scenes the recommender selected.

What is claimed is:

1. A program recommending apparatus that transmits program recommendation information to a program recommended apparatus via a communication circuit, said program recommending apparatus comprising:
a program information acquiring section for supplying program information about a program currently broadcast or about a program to be broadcast in the future;
a program recommendation information generating section for generating, according to a program currently viewed or to a program designated from among the program information supplied from said program information acquiring section, program recommendation information that includes information for identifying the program;
a recommendation destination identifying section for generating a list of a program recommended apparatus to which the program recommendation information can be transmitted;
an interface for displaying the list, and for receiving an input for designating a program recommended apparatus; and
a communication section for transmitting the program recommendation information to said program recommended apparatus designated.

2. The program recommending apparatus according to claim 1, wherein said program recommendation information generating section inserts into the program recommendation information at least one of a program ID for identifying the program, a program title, a broadcast time period, a broadcasting channel, a keyword, and a genre.

3. The program recommending apparatus according to claim 1, wherein said program recommendation information generating section decides a recommendable program to be inserted into the program recommendation information according to a viewing time period of a same program of a program recommender.

4. The program recommending apparatus according to claim 1, wherein said program recommendation information generating section generates a software capable of operating as program recommending means in the program recommended apparatus which is a destination of the transmission, and inserts the program into the program recommendation information.

5. The program recommending apparatus according to claim 1, wherein said interface receives a message input from a program recommender; and
said communication section transmits to said program recommended terminal the message along with the program recommendation information.

6. The program recommending apparatus according to claim 1, further comprising a record/playback section for recording and playing back a program, and for generating and holding program information about the recorded program, wherein
said program recommendation information generating section generates the program recommendation information from the recorded program currently viewed or from a program designated from among the program information.

7. The program recommending apparatus according to claim 6, wherein said program recommendation information generating section inserts a program that is reserved for recording into the program recommendation information.

8. The program recommending apparatus according to claim 1, wherein said interface receives an input for designating a particular scene in a recommendable program; and
said program recommendation information generating section inserts information about the particular scene into the program recommendation information.

9. A program recommended apparatus that receives program recommendation information transmitted from a program recommending apparatus via a communication circuit, said program recommended apparatus comprising:
a program information acquiring section for supplying program information about a program currently broadcast or about a program to be broadcast in the future;
a communication section for receiving the program recommendation information transmitted from said program recommending apparatus;
a program recommending source management table for storing authorization information for making a decision as to whether to authorize a program recommendation from said program recommending apparatus;
a program recommending source authentication section for supplying, referring to said program recommending source management table, authorization information given to said program recommending apparatus;
a program recommending section, referring to the authorization information supplied from said program recommending source authentication section, for identifying, when said program recommending apparatus is provided with authorization of recommendation authorized, a program included in the program recommendation information from among the program information supplied from said program information acquiring section; and
a display section for displaying recommendation information based on the program recommendation information about the program identified by said program recommending section.

10. The program recommended apparatus according to claim 9, wherein when the program recommendation information includes a program to be broadcast in the future, said program recommending section have said display section display the program and recommendation information based on the program recommendation information when broadcasting start time of the program draws near.

11. The program recommended apparatus according to claim 9, further comprising a record/playback section for recording and playing back a program, and for generating and holding program information about the recorded program, wherein
said program recommending section, referring to the program information about the recorded program, identifies from recorded programs a program included in the program recommendation information.

12. The program recommended apparatus according to claim 11, wherein when a program included in the program recommendation information is not contained in the recorded programs, said program recommending section identifies a program from among the program information supplied from said program information acquiring section.

13. The program recommended apparatus according to claim 11, wherein when the program recommendation information includes a program to be broadcast in the future, said program recommending section has said record/playback section carry out recording reservation of the program.

14. The program recommended apparatus according to claim 13, wherein when completing recording of the program to be broadcast in the future, which is included in the program recommendation information, said record/playback section has said display section display the recorded program and recommendation information based on the program recommendation information.

15. The program recommended apparatus according to claim 9, wherein said program recommending section edits a recorded program according to information that designates a particular scene in a recommendable program included in the program recommendation information, and generates a software for displaying only the particular scene.

16. A program recommending system that transmits program recommendation information from a program recommending apparatus to a program recommended apparatus via a communication circuit, wherein
said program recommending apparatus:
generates, according to a program designated from a program currently viewed or to a program designated from among program information about a program currently broadcast and about a program to be broadcast in the future, the program recommendation information including information for identifying the program; and
transmits the program recommendation information to a program recommended apparatus designated from a list of program recommended apparatuses to which the program recommendation information can be transmitted, and wherein
said program recommended apparatus that receives the program recommendation information:
referring to a program recommending source management table that stores authorization information for making a decision as to whether to authorize program recommendation from said program recommending apparatus, displays, when said program recommending apparatus is provided with authorization of recommendation authorized, the recommendation information based on the program recommendation information.
